(19) United States
(12) Patent Application Publication
(10) Pub. No.: US 2014/0247187 A1
(43) Pub. Date: Sep. 4, 2014

(54) ESTIMATION OF TIME DIFFERENCE OF ARRIVAL (TDOA) IN MULTIPATH ENVIRONMENTS BASED ON SUB-NYQUIST RATE SAMPLING

(71) Applicant: Koji HARADA, Kobe (JP)

(72) Inventor: Koji HARADA, Kobe (JP)

(73) Assignee: AGILENT TECHNOLOGIES, INC., Loveland, CO (US)

(21) Appl. No.: 13/599,166

(22) Filed: Aug. 30, 2012

(51) Int. Cl. G01S 5/02

(52) U.S. Cl. CPC G01S 5/0273
USPC 342/465

(57) ABSTRACT

A method is provided for to determining a time difference of arrival (TDOA) between a first signal and a second signal. The method includes sampling a first signal at a sub-Nyquist rate to provide a first sampled signal; sampling a second signal at the sub-Nyquist rate to provide a second sampled signal, the first and second signals representing corresponding multipath channels; cross-correlating the first and second sampled signals; and determining an estimate of the TDOA between the first and second signals based on the sampled first and second signals.

### BACKGROUND

Multilateration is a position location technique commonly used in civil and military surveillance applications to locate an unknown transmitter, such as in an aircraft or other vehicle, bugging devices, or unauthorized cellular phones. One way to perform multilateration is through the use of the Time Difference of Arrival (TDOA), that is, the difference in time it takes a radio frequency (RF) signal from the transmitter to propagate through channels to two receivers or sensor sites with known locations.

Generally, TDOA is calculated from cross-correlation of every pair of the sensors involved in the measurement. This known method is limited to determining TDOA based on a propagation channel from the unknown transmitter to each sensor consisting of a single line-of-sight (LOS) path. However, because propagation channels can consist of multiple paths having different time delays, the known cross-correlation method is susceptible to error when an aggregate TDOA value is calculated that is influenced by the multiple paths. As can be appreciated, in many environments (e.g., urban environments), most channels consist of multipath channels due to numerous reflections that occur between the transmitter and the receiver, e.g., from buildings, ground, etc. These reflections are not easily predicted, and as noted above, application of the known cross-correlation method results in significant error in the TDOA, and ultimately the location of the unknown transmitter.

There is therefore a need to estimate TDOA in multipath environments that overcomes at least the shortcomings of the known TDOA method using cross-correlation described above.

### SUMMARY

In a representative embodiment, a method is provided for estimating time difference of arrival (TDOA) between first and second multipath signals, where each of the first and second signals represents a multipath channel. The method includes sampling the first signal at a sub-Nyquist rate to provide a first sampled signal; sampling the second signal at the sub-Nyquist rate to provide a second sampled signal; cross-correlating the first and second sampled signals; and determining an estimate of the TDOA between the first and second signals based on the cross-correlated first and second sampled signals.

In another representative embodiment, a method is instantiated in a computer readable medium storing programming instructions and executable by one or more processors, to determine TDOA between a first signal and a second signal. The method includes sampling a first signal at a sub-Nyquist rate to provide a first sampled signal; sampling a second signal at the sub-Nyquist rate to provide a second sampled signal, the first and second signals representing corresponding multipath channels of an input signal from a transmitter; cross-correlating the first and second sampled signals; and determining an estimate of the TDOA between the first signal and the second signal based on the cross-correlated first and second sampled signals.

In accordance with another representative embodiment, an apparatus includes first and second devices and a module. The first device is configured to sample a first signal from a first sensor at a sub-Nyquist rate to provide a first sampled signal. The second device is configured to sample a second signal from a second sensor at the sub-Nyquist rate to provide a second sampled signal. The module is configured to cross-correlate the first and second sampled signals and to provide estimates of TDOAs between the first and second signals corresponding to a sampling period based on the cross-correlated sampled signals. The first and second signals correspond to an input signal from a transmitter.

### BRIEF DESCRIPTION OF THE DRAWINGS

The representative embodiments are best understood from the following detailed description when read with the accompanying drawing figures. Wherever applicable and practical, like reference numerals refer to like elements.

FIG. 1 is a simplified block diagram of an apparatus for estimating time difference of arrival (TDOA) between multipath signals, according to a representative embodiment.

FIG. 2 is a simplified block diagram of an apparatus for estimating TDOA between multipath signals, according to a representative embodiment.

FIG. 3 is a simplified schematic diagram of a mathematical model employed by an apparatus for estimating TDOA between multipath signals, according to a representative embodiment.

FIG. 4 is a flow chart of a method for estimating TDOA between multipath signals, according to a representative embodiment.

### DETAILED DESCRIPTION

In the following detailed description, for purposes of explanation and not limitation, illustrative embodiments disclosing specific details are set forth in order to provide a thorough understanding of embodiments according to the present teachings. However, it will be apparent to one having had the benefit of the present disclosure that other embodiments according to the present teachings that depart from the specific details disclosed herein remain within the scope of the appended claims. Moreover, descriptions of well-known devices and methods maybe omitted so as not to obscure the description of the example embodiments. Such methods and devices are within the scope of the present teachings.

Generally, it is understood that as used in the specification and appended claims, the terms “a”, “an” and “the” include both singular and plural referents, unless the context clearly dictates otherwise. Thus, for example, “a device” includes one device and plural devices.

As used in the specification and appended claims, and in addition to their ordinary meanings, the terms “substantial” or “substantially” mean to within acceptable limits or degree. For example, “substantially cancelled” means that one skilled in the art would consider the cancellation to be acceptable. As a further example, “substantially removed” means that one skilled in the art would consider the removal to be acceptable.

As used in the specification and the appended claims and in addition to its ordinary meaning, the term “approximately” means to within an acceptable limit or amount to one having ordinary skill in the art. For example, “approximately the same” means that, one of ordinary skill in the art would consider the items being compared to be the same.

The present teachings relate generally to a method of estimating TDOA, which is ultimately used to determine the position of a transmitter, and an apparatus for implementing the method. The TDOA estimates and amplitude estimates are determined based on output signals of multipath channels (multipath signals) received at sensors. Geolocation results, indicating the geographic location of the transmitter, are obtained based on the multipath TDOA and amplitude estimates obtained according to representative embodiments. For example, among all the multipath TDOA estimates from each sensor pair, the TDOA estimate based on the two line-of-sight (LOS) paths (LOS TDOA estimate) is combined with LOS TDOA estimates from other sensor pairs to perform geolocation of the transmitter. The LOS TDOA estimate for each sensor pair can be identified based on the assumption that the two LOS signals and the corresponding LOS TDOA estimates have the largest gain. Thus, according to the present teachings, the LOS TDOA estimates for the two signals in a multipath environment are determined more accurately without being affected by other paths. This in turn indicates more accurate geolocation of the transmitter.

In an embodiment, an innovation rate sampling (IRS) approach is used to determine at least an initial TDOA estimate using sample signals from the sensor pair. In the IRS approach, the minimum sampling rate for reconstruction of a signal is determined by the rate of innovation (the degree of freedom per unit time) of the signal. Since cross-correlation signals of the outputs of two multipath channels are parametric signals for which the degree of freedom is determined by the number of multipaths, the cross-correlation signals have relatively low innovation rate. According to the present teachings, the IRS approach is applied to develop a multipath TDOA technique based on sub-Nyquist-rate samples.

The sub-Nyquist technique of the present teachings offers several practical advantages. Notably, reduced sampling rates allow for the implementation of the methods and apparatuses in comparatively less complex and less expensive components. For example, because sampling can be performed on signals with a comparatively reduced bandwidth determined by a sampling kernel, for example, a commercially available analog-to-digital converter (ADC) can be used. As such, when the transmission signal has a comparatively wide bandwidth, but the channels consist of just one or two paths, the reduction of the sampling rate becomes significant compared to known sampling schemes. Illustratively, a reduction ratio in the sampling rate can be up to 10 or more. Moreover, given the same observation time span, the number of samples can be reduced by the same ratio of the sampling rate reduction, while performance of TDOA estimates is kept basically unchanged.

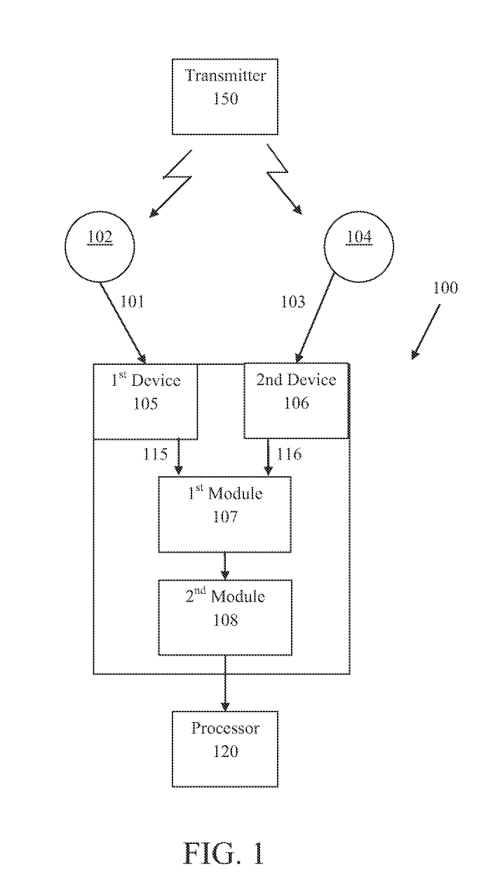

FIG. 1 is a simplified block diagram of an apparatus 100, which is configured to determine TDOA based on multipath signals transmitted by a transmitter 150, in accordance with a representative embodiment.

Referring to FIG. 1, the transmitter 150 transmits a signal that is received by a sensor pair, including first sensor 102 and second sensor 104, which are at different geographic locations. The apparatus 100 receives a first signal 101 from the first sensor 102 and a second signal 103 from the second sensor 104 corresponding to the received signal transmitted by the transmitter 150. It is assumed that one or both of the first and second signals 101, 103 are multipath signals.

In the depicted embodiment, the apparatus 100 includes first device 105, second device 106, first module 107 and second module 108. The first device 105 is configured to receive and sample the first signal 101 at a sub-Nyquist rate, and to provide first sampled signal 115 to the first module 107. The second device 106 is configured to receive and sample the second signal 103 at the sub-Nyquist rate to provide second sampled signal 116 to the first module 107. The first and second sampled signals 115, 116 of each sample constitute a sample pair corresponding to different path signals in one or both of the first and second signals 101, 103. The first module 107 is configured to cross-correlate the first and second sampled signals 115, 116. In accordance with a representative embodiment, the first module 107 is configured to provide an estimate of a time difference of arrival (TDOA) between the first and second signals 101, 103 based on each sample pair of the first and second sampled signals 115, 116. In a representative embodiment, the method of sampling at the sub-Nyquist rate and cross-correlating the first and second signals 115, 116 is an innovation rate sampling (IRS) approach, described more fully below.

The apparatus 100 optionally includes a second module 108. As described more fully below, the second module 108 receives initial TDOA estimates from the first module 107 and further refines the TDOA estimates. For example, in a representative embodiment, the second module 108 further refines the initial TDOA estimates based on a nonlinear least square (NLS) method, described more fully below. The (initial or refined) TDOA estimates are provided to processor 120, which may perform geolocation calculations using select TDOA estimates to determine the location of the transmitter 150, according to any geolocation technique known in the art. For example, the processor 120 may identify the LOS TDOA estimate from among the TDOAs of each sensor pair, and use the LOS TDOA estimates for determining the location of the transmitter 150, as discussed below.

The first and second modules 107, 108 and the processor 120 are processing devices that may be implemented by a processor, application specific integrated circuits (ASICs), field-programmable gate arrays (FPGAs), or combinations thereof, using software, firmware, hard-wired logic circuits, or combinations thereof. When using a computer processor, a memory may be included for storing executable software/firmware and/or executable code that allows it to perform the various functions. The memory may be a non-transitory computer readable medium, and may include any number, type and combination of random access memory (RAM) and read-only memory (ROM), for example.

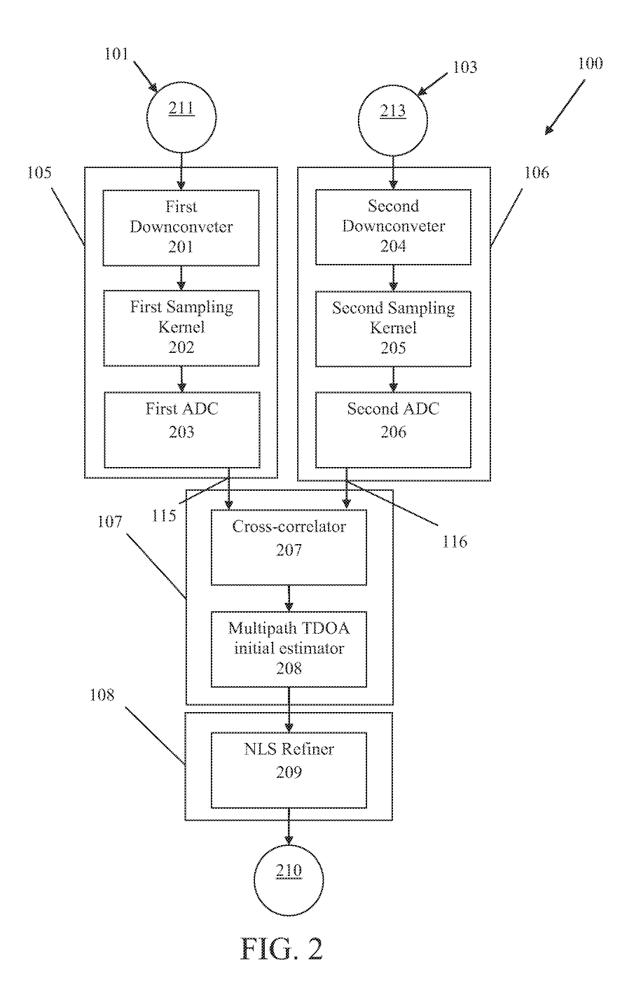

FIG. 2 is a more detailed block diagram of the apparatus 100, in accordance with a representative embodiment.

Referring to FIG. 2, the apparatus 100 receives the first and second signals 101, 103 at first and second input nodes 211, 213, respectively, at least one of the first and second signals being a multipath signal. The apparatus 100 also includes the first device 105 configured to sample the first signal 101 at a sub-Nyquist rate and to provide the first sampled signal 115 to the first module 107, and the second device 106 configured to sample the second signal 103 at the sub-Nyquist rate to provide the second sampled signal 116 to the first module 107. More particularly, each of the first signal 101 and the second signal 103 are sampled at a rate less than the Nyquist rate and greater than or equal to an innovation rate.

In the depicted representative embodiment, the first device 105 includes first downconverter 201, first sampling kernel 202, and first ADC 203. Generally, the first downconverter 201 receives the first signal 101 and downconverts the (RF) carrier to baseband using a local oscillator (not shown), for example. The downconverted signal passes through the first sampling kernel 202, which functions essentially as a first lowpass filter to provide a first band limited signal. The first ADC 203 samples the first band limited signal at a sub-Nyquist rate to provide the first sampled signal 115 at the sample rate. Similarly, the second device 106 includes second downconverter 204, second sampling kernel 205, and second ADC 206. The second downconverter 204 receives the second signal 103 and downconverts the (RF) carrier to baseband using a local oscillator (not shown), for example. The downconverted signal passes through the second sampling kernel 205, which functions essentially as a second lowpass filter to provide a second band limited signal. The second sampling kernel 205 has the same filter response as the first sampling kernel 202. The second ADC 206 samples the second band limited signal at the same sub-Nyquist rate to provide the second sampled signal 116 at the sample rate.

The sub-Nyquist-rate first and second sampled signals 115, 116 are received by the first module 107 as a sample pair each sample period. The first module 107 includes cross-correlator 207 and multipath TDOA initial estimator 208. The cross-correlator 207 is configured to determine the cross-correlation of the first and second sampled signals 115, 116, and the multipath TDOA initial estimator 208 determines initial estimates of multipath TOO As by further processing the cross-correlation results, for example, by applying an annihilating filter method as discussed below. The sampling and cross-correlation to provide initial TDOA estimates are performed according to an IRS approach as detailed below, for example. The initial TDOA estimates are provided to the second module 108, which includes NLS refiner 209. The NLS refiner 209 further refines the initial TDOA estimates based on the nonlinear least squares (NLS) criterion to take advantage of superior statistical properties of the NLS method. The NLS refiner 209 outputs the refined TDOA estimates, along with amplitude estimates, corresponding to the sample pairs at output node 210.

As mentioned above, geolocation results may be obtained using the multipath TDOA and amplitude estimates. For example, among all the refined TDOA estimates, one is likely based on two line-of-sight (LOS) paths of the first and second signals 101, 103, respectively, referred to as the LOS TDOA estimate. The LOS TDOA estimate may be distinguished from the other refined TDOA estimates, for example, by introducing the assumption that the LOS path in each of the first and second signals 101, 103 has the largest gain among the multiple paths. Thus, as compared to a conventional cross-correlation method, for example, the depicted embodiment is able to determine the LOS TDOA estimate in a multipath environment without being affected by other paths (in an ideal case). This in turn indicates more accurate geolocation of the transmitter 150.

The steps described above with reference to FIG. 2 are repeated for every pair of sensors (including the sensor pair consisting of the first and second sensors 102, 104) to obtain corresponding LOS TDOA estimates. For example, if the there is one additional sensor (i.e., in addition to the first sensor 102 and the second sensor 104), the steps described above are repeated for two more sensor pairs: one consisting of the first sensor 101 and the additional sensor, and the other consisting of the second sensor 102 and the additional sensor. This results in two more corresponding LOS TDOA estimates. To perform geolocation according to this example, the three LOS TDOA estimates are combined in an appropriate manner, as is known in the art regarding multilateration, to determine the location of the transmitter 150.

As discussed above, according to various embodiments, the IRS approach and the NLS method are combined to provide TDOA estimates of multipath signals (or channels). As a result, TDOA estimates having favorable NLS performance are provided from samples taken at sub-Nyquist sampling rates. Given a fixed observation time, this means that the same level of performance is achievable from fewer samples. The estimates of the Fourier series coefficients obtained via the IRS approach may then be employed to drive iterative minimization based on the NLS method, which works to refine the time-delay and amplitude estimates obtained via the IRS approach, and provides asymptotically unbiased estimates, as discussed below.

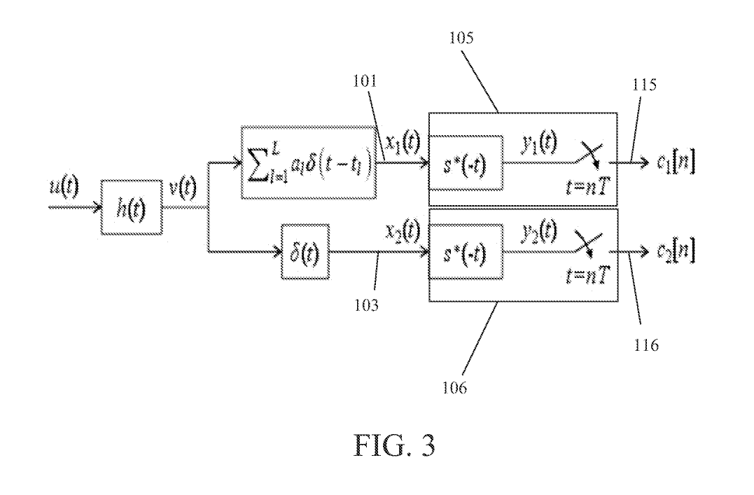

FIG. 3 is a schematic diagram of a mathematical model for TDOA estimation, according to a representative embodiment. In this model, the second channel is assumed to have a single-path channel to clearly demonstrate the embodiments. Extension to the multipath case may be accomplished in a straight-forward manner by following the same argument.

Referring to FIG. 3, u(t) is a continuous-time, circularly-symmetric complex white random signal that has variance σᵤ², and h(t) is a known continuous-time lowpass filter having limited-energy. The filter output v(t) simulates a signal transmitted by a transmitter (e.g., transmitter 150), which is received by two sensors (e.g., first and second sensors 102, 104). The filter output v(t) may be written as Equation (1):

v(t)=∫_{ξ∈T}_{ₕ}h(ξ)u(t−ξ)dξ (1)

As stated above, h(t) is known. The continuous-time lowpass filter h(t) is assumed to have time support Tₕ having infinite span: [Tₕ]<∞, i.e., h(t)=0 for t∉Tₕ. The filter h(t) has a Fourier transform indicated by Equation (2):

H(ω)=∫_{t∈T}_{ₕ}h(t)e^{-jωt}dt. (2)

The filter output signal v(t) is then passed through two multipath delay channels, which simulate multipath channels from a sensor pair (e.g., first and second sensors 102, 104) to apparatus 100, for example. The outputs of the multipath delay channels are given by Equations (3)-(6), where x₁ is the output signal of the first channel (e.g., first signal 101) and x₂ is the output signal of the second channel (e.g., second signal 103):

$$\begin{matrix}{x}_{1} ( t ) = {\sum }_{l = 1}^{L} {a}_{l} v ( t - {t}_{l} ) & ( 3 ) \\ {x}_{2} ( t ) = v ( t ) \\ where & ( 4 ) \\ {a}_{l} ∈ C ( l = 1 , … , L ) & ( 5 ) \\ {t}_{l} ∈ [ 0 , p ) ( l = 1 , … , L ) & ( 6 )\end{matrix}$$

The parameters aₗ and tₗ denote deterministic but unknown amplitudes and time-delays of the first channel, respectively, with p>0 being the upper bound of the delays. For the sake of simplicity, the second channel is assumed to have unity gain and zero delay in this example without loss of generality.

The output signals x₁(t) and x₂(t) are sampled uniformly at t=nT, where T is the sampling time interval, for example, by the first and second devices 105, 106 of the apparatus 100. Let s(t) denote a sampling kernel, such as first and second sampling kernels 202, 205. Since applying a sampling kernel can be considered as filtering with s*(−t), the signals after passing through the kernel (e.g., first and second band limited signals) can be written as shown in Equations (7)-(8):

y₁(t)=∫_{-∞}^{∞}x₁(ξ)s*(ξ−t)dξ (7)

y₂(t)=∫_{-∞}^{∞}x₂(ξ)s*(ξ−t)dξ. (8)

Then the samples, which correspond to the first and second sampled signals 115, 116, for example, are given by Equations (9)-(10):

c₁[n]=y₁(nT) (9)

c₂[n]=y₂(nT). (10)

The sampling kernel s(t) is assumed to have limited energy and time support Tₛ whose span is finite: [Tₛ]<∞. Thus, sampling kernel s(t) has the Fourier transform of Equation (11):

S(ω)=∫_{t∈T}_{ₛ}s(t)e^{-jωt}dt. (11)

It is assumed that the output signals x₁(t) and x₂(t) are available for sampling during the time with length T_{obs}, referred to a the observation time. Given the observation time T_{obs}, sampling the output signals x₁(t) and x₂(t) with the interval T produces N=T_{obs}/T sample pairs {c₁[n], c₂[n]}, n=0, . . . , N−1. An objective of the apparatus 100, according to various embodiments, is to obtain consistent estimates of {aₗ, tₗ}ₗ₌₁^{L} from the N sample pairs taken at sub-Nyquist sampling rates.

According to various embodiments, the conventional IRS approach, described for example by Tur et al., “Innovation Rate Sampling of Pulse Streams with Application to Ultra Sound Imaging,” IEEE TRANS. ON SIGNAL PROCESS., vol. 59, no. 4, pp. 1827-1842 (April 2011), and Vetterli et al., “Sampling Signals with Finite Rate of Innovation,” IEEE TRANS. ON SIGNAL PROCESS., vol. 50, no. 6l, pp. 1417-1428 (June 2002), which are hereby incorporated by reference, is reformulated to fit the filtered random signal model described above. Asymptotic treatment is given first, followed by the case in which a limited number of sample pairs are available. The minimum sampling rate that still allows asymptotically perfect recovery of {aₗ,tₗ}ₗ₌₁^{L} has been shown to be equal to the innovation rate, denoted by ρ, of the pulse stream, which is defined by Equation (12):

$$ρ = \frac{2 L}{p} \qquad ( 12 )$$

This makes an intuitive sense because a stream of L pulses is completely characterized by specifying 2L parameters (L amplitudes and L delays) with each delay confined in the time interval of p. Thus, sub-Nyquist sampling rates that lie within (ρ, 1/T_{NQ}) may be considered, where 1/T_{NQ} is the near-Nyquist rate of v(t). Note the near-Nyquist rate of v(t) is used instead of the ordinary Nyquist rate (defined by twice the maximum frequency contained in v(t)) because for [Tₕ]<∞ the ordinary Nyquist rate of v(t) is infinite. The near-Nyquist rate 1/T_{NQ} is chosen so that |H(π/T_{NQ})| is sufficiently small.

Next, frequency-domain expressions may be obtained from the sub-Nyquist-rate samples c₁[n] and c₂[n], for which existing sinusoidal estimation methods are applied to estimate the time delays. In the following discussion, the order of sampling operation and computation of the cross-correlation are exchanged for purposes of discussion to keep notations simple. This order exchange is easily justified by examining frequency-domain behaviors of these two operations.

The cross-correlation of the first and second band limited signals y₁(t) and y₂(t) after passing through the kernels can be written as shown in Equation (13):

$$r ( τ ) = E \{ {y}_{1} ( t ) {y}_{2}^{*} ( t - τ ) \} = {σ}_{u}^{2} {\sum }_{l = 1}^{L} {a}_{l} g ( τ - {t}_{l} ) \qquad ( 13 )$$

The function g(t) is defined by Equation (14), where * representing the convolution:

g(t)=h(t)*h*(−t)*s(t)*s*(−t) (14)

Also, function g(t) has time support as shown in Equation (15):

T_{g}=[−[Tₕ]−[Tₛ], [Tₕ]+[Tₛ]]. (15)

The Fourier transform of r(τ), which equivalently is the cross-spectrum of y₁(t) and y₂(t), is given by Equation (16):

$$\begin{matrix}R ( ω ) = {\int }_{- ∞}^{∞} r ( τ ) {e}^{- j ω τ} d τ \\ = {σ}_{u}^{2} {\vert H ( ω ) \vert}^{2} {\vert S ( ω ) \vert}^{2} {\sum }_{l = 1}^{L} {a}_{l} {e}^{- jω {t}_{l}} .\end{matrix} \qquad ( 16 )$$

Equation (16) is discretized because further processing is performed on discrete points in the frequency domain. Therefore, periodic summation of r(τ) is considered because doing so leads to the Fourier series representation of Equation (16). Letting \tilde{p} denote the period, the periodic summation of r(τ) can be written as shown in Equation (17):

$$\tilde{r} ( τ ) = {\sum }_{d ∈ Z} r ( τ + \tilde{p} d ) . \qquad ( 17 )$$

Applying known Poisson's summation formula, \tilde{r}(τ) can be rewritten using Fourier series coefficients as shown in Equation (18):

$$\tilde{r} ( τ ) = \frac{1}{\tilde{p}} {\sum }_{k ∈ Z} R ( \frac{2 π}{\tilde{p}} k ) {e}^{j \frac{2 π}{\tilde{p}} k τ} . \qquad ( 18 )$$

Following the IRS approach, a set of M consecutive indices may be defined as K={k₀, . . . , k₀+M−1} for which Equation (19) is satisfied:

$$\vert H ( \frac{2 π k}{\tilde{p}} ) \vert \neq 0 , for all k ∈ K \qquad ( 19 )$$

In Equation (19), k₀∈Z determines the offset of the frequency band specified by K. It may be assumed such a set exists. Determining the sampling time interval as T=\tilde{p}/M, discrete-time samples of \tilde{r}(τ) at times τ=nT, n∈Z can be written as in Equation (20):

$$\tilde{r} ( nT ) = \frac{1}{\tilde{p}} {\sum }_{k ∈ Z} R ( \frac{2 π}{\tilde{p}} k ) {e}^{j \frac{2 π}{M} kn} . \qquad ( 20 )$$

Note that

$${e}^{j \frac{2 π}{M} kn}$$

in Equation (20) is periodic in k with the period M, i.e.,

$${e}^{j \frac{2 π}{M} ( k + mM ) n} = {e}^{j \frac{ 2 π}{M} kn} , m ∈ Z .$$

Therefore, Equation (20) may be rewritten as Equation (21):

$$\begin{matrix}\tilde{r} ( nT ) = \frac{1}{\tilde{p}} {\sum }_{k ∈ K} {\sum }_{m ∈ Z} R ( \frac{2 π}{\tilde{p}} ( k + mM ) ) {e}^{j \frac{2 π}{M} kn} \\ = \frac{1}{\tilde{p}} {\sum }_{k ∈ K} {\sum }_{m ∈ Z} R ( \frac{2 π}{\tilde{p}} k + \frac{2 π}{T} m ) {e}^{j \frac{2 π}{M} kn} \\ = \frac{1}{M} {\sum }_{k ∈ K} {R}_{d} [ k ] {e}^{j \frac{2 π}{M} kn}\end{matrix} \qquad ( 21 )$$

In Equation (21), R_{d}[k] may be defined as shown in Equation (22):

$${R}_{d} [ k ] = \frac{1}{T} {\sum }_{m ∈ Z} R ( \frac{2 π}{\tilde{p}} k + \frac{2 π}{T} m ) . \qquad ( 22 )$$

In Equation (22), the terms corresponding to m≠0 represent frequency-domain aliasing that appear when the sampling rate 1/T is smaller than the near-Nyquist rate 1/T_{NQ}.

Suppose now that the sampling kernel s(t) satisfies the general condition derived by the IRS approach, e.g., described by Tur et al., allowing perfect reconstruction of periodic pulse streams from the minimal number of samples, which is stated as shown in Equation (23):

$$S ( ω ) = \{ \begin{matrix}nonzero & ω = 2 π k / \tilde{p} , k ∈ K \\ 0 & ω = 2 π k / \tilde{p} , k ∉ K \\ arbitrary & otherwise .\end{matrix} \qquad ( 23 )$$

With this condition, from Equation (16), Equation (24) follows:

$$R ( \frac{2 π}{\tilde{p}} k ) = \{ \begin{matrix}nonzero & k ∈ K \\ 0 & k ∉ K\end{matrix} \qquad ( 24 )$$

Then, all the aliasing terms in R_{d}[k] in Equation (22) (e.g., contributions from terms associated with m≠0) are suppressed. That is, Equation (22) is reduced to Equation (25):

$${R}_{d} [ k ] = \frac{1}{T} R ( \frac{2 π}{\tilde{p}} k ) . \qquad ( 25 )$$

Vector d is allowed to denote an M-dimensional vector defined as shown in Equation (26):

d=[\tilde{r}(0) \tilde{r}(T) . . . \tilde{r}((M−1)T)]^{T}. (26)

Then, Equation (21) has an equivalent vector representation, as shown in Equation (27):

$$d = \frac{1}{M} M {W}^{H} p \qquad ( 27 )$$

In Equation (27), vector p is the vector containing the M Fourier coefficients of \tilde{r}(nT), given by Equation (28):

$$\begin{matrix}p = {[ {R}_{d} [ {k}_{0} ] … {R}_{d} [ {k}_{0} + M - 1 ] ]}^{T} \\ = {\frac{1}{T} [ R ( \frac{2 π}{\tilde{p}} {k}_{0} ) … R ( \frac{2 π}{\tilde{p}} ( {k}_{0} + M - 1 ) ) ]}^{T}\end{matrix} \qquad ( 28 )$$

Matrix W is an M-point discrete Fourier transform (DFT) matrix, i.e., its mk-th entry is e^{-j(2π/M)(m-1)(k-1)}. In addition, M is an M×M diagonal matrix defined as shown in Equation (29), where diag(v₁, . . . , v_{M}) denotes a diagonal matrix with the diagonal element defined by v₁, . . . , v_{M}:

$$M = diag ( 1 , {e}^{j ( 2 π / M ) {k}_{0}} , … , {e}^{j ( 2 π / M ) {k}_{0} ( M - 1 )} ) \qquad ( 29 )$$

Equation (27) essentially suggests an M-point inverse-DFT (IDFT) relationship with frequency shift implemented in M.

From Equation (16), the Fourier coefficient vector of Equation (28) may be rewritten as shown in Equation (30):

p=MSHz (30)

The parameters of Equation (30) are provided as follows by Equations (31)-(33):

$$\begin{matrix}S = diag ( {\vert S ( \frac{2 π}{\tilde{p}} {k}_{0} ) \vert}^{2} , … , {\vert S ( \frac{2 π}{\tilde{p}} ( {k}_{0} + M - 1 ) ) \vert}^{2} ) & ( 31 ) \\ H = diag ( {\vert H ( \frac{2 π}{\tilde{p}} {k}_{0} ) \vert}^{2} , … , {\vert H ( \frac{2 π}{\tilde{p}} ( {k}_{0} + M - 1 ) ) \vert}^{2} ) & ( 32 ) \\ z = \frac{2 π}{\tilde{p}} V ( t ) a & ( 33 )\end{matrix}$$

Further, vector z is an M-dimensional vector with its m-th entry given by Equation (34), and vector a=[a₁, . . . , a_{L}]^{T}:

$${z}_{m} = \frac{2 π}{\tilde{p}} {\sum }_{l = 1}^{L} {a}_{l} {e}^{- j \frac{2 π}{\tilde{p}} ( {k}_{0} + m - 1 ) {t}_{l}} , m = 1 , … , M \qquad ( 34 )$$

The M×L Vandermonde matrix V(t), where t=[t₁, . . . , t_{L}]^{T}, is defined by Equation (35):

$$V ( t ) = [ \begin{matrix}{e}^{- j \frac{2 π}{\tilde{p}} {k}_{0} {t}_{1}} & … & {e}^{- j \frac{2 π}{\tilde{p}} {k}_{0} {t}_{L}} \\ ⋮ & & ⋮ \\ {e}^{- j \frac{2 π}{\tilde{p}} {( {k}_{0} + M - 1 )}_{{t}_{1}}} & … & {e}^{- j \frac{ 2 π}{\tilde{p}} ( {k}_{0} + M - 1 ) {t}_{L}}\end{matrix} ] \qquad ( 35 )$$

Further, the M×L Vandermonde matrix V(t) has full column rank under the conditions that M≧L and the time-delays are distinct, i.e., tᵢ≠tⱼ, for all i≠j, as described by Stoica et al., SPECTRAL ANALYSIS OF SIGNALS, Pearson Prentice Hall, Upper Saddle River, N.J. (2005), Appendix Section A.6, which is hereby incorporated by reference.

Since complex exponentials in Equation (34) are periodic in tₗ with the period \tilde{p}, the following relation of Equation [36] must be satisfied to ensure unique recovery of {tₗ}ₗ₌₁^{L}:

$$0 \leq \frac{2 π}{\tilde{p}} {t}_{l} < \frac{2 π}{\tilde{p}} p \leq 2 π , l = 1 , … , L \qquad ( 36 )$$

This leads to inequality \tilde{p}≧p. In contrast, the annihilating filter method (Prony's method) recovers {tₗ}ₗ₌₁^{L} from the phase of e^{-j2πt}^{ₜ}^{/\tilde{p}}, as described by Stoica et al., for example. For closely-spaced delays, the phase difference −2π(tᵢ−tⱼ)/\tilde{p}, i≠j becomes smaller as \tilde{p} goes larger. Therefore, estimation of such delays becomes more difficult with large \tilde{p}, For example, in simulation, setting \tilde{p}=2p has resulted in increased estimation error than \tilde{p}=p. Thus, it may be assumed that \tilde{p}=p.

From Equations (27) and (30), Equation (37) follows:

d=MW^{H}SHz. (37)

Noting that matrices H, S and M are invertible by construction, and (1/M)WW^{H} is an identity matrix, it is now seen that the vector z can be obtained from d as shown in Equation (38):

$$z = \frac{1}{M} {H}^{- 1} {S}^{- 1} W {M}^{- 1} d . \qquad ( 38 )$$

Evidently, given the vector z, Equation (33) is a standard problem of finding the frequencies and amplitudes of the sum of L complex exponentials, as discussed by Vetterli et al. This problem may be solved as long as |K|=M≧2L, where |·| denotes the cardinality of a set, by applying the annihilating filter method. As is known in the art, the annihilating filter method is a parametric estimation method for line spectra with super-resolution capability, which is essentially the classic all-pole estimation method for rational spectra known as Prony's (or Yule-Walker) method applied to line-spectral estimation, also discussed by Vetterli et al.

The cross-correlation vector d in Equation (26) may be practically estimated from a limited number of samples pairs. The parameter γ≧1 may be defined as the smallest integer that satisfies Equation (39):

γp≧[Tₕ]+[Tₛ]=[T_{g}]/2 (39)

In Equation (39), Tₕ, Tₛ and T_{g} denote the time support of h(t), s(t) and g(t) respectively, with [T] denoting the span of T. Since the support of r(τ) in Equation (13), denoted by Tᵣ, is Tᵣ=[−[T_{g}]/2, [T_{g}]/2+p), we see from Equation (39) that Tᵣ lies within the interval [−γp, (γ+1)p]. Therefore, the infinite sum in Equation (17) is replaced by a finite sum. Specifically, for discrete times τ=nT, n=0, . . . , M−1, we can rewrite Equation (17) as Equation (40):

$$\tilde{r} ( nT ) = {\sum }_{d = - γ}^{γ} r ( nT - pd ) = {\sum }_{d = - γ}^{γ} r ( ( n - dM ) T ) \qquad ( 40 )$$

In order for γ to exist, s(t) must be compactly supported too. This puts the second condition on s(t) for perfect recovery of {aₗ, tₗ}ₗ₌₁^{L} in an asymptotic sense. One example of s(t) that satisfies both of the two conditions is the class known as the sum-of-sincs (SoS) in the frequency domain. It is compactly supported, and also satisfies Equation (23). The SoS class is given by the sum of sincs in the frequency domain, as described by Tur et al., for example, and shown by Equation (41):

$$G ( ω ) = {\sum }_{k ∈ K} {b}_{k} sin c ( \frac{ω}{2 π / p} - k ) \qquad ( 41 )$$

In Equation (41), bₖ∈C, k∈K is a nonzero weighting factor. The inverse Fourier transform of G(ω) gives Equation (42):

$$g ( t ) = \frac{1}{p} rect ( \frac{t}{p} ) {\sum }_{k ∈ K} {b}_{k} {e}^{j \frac{2 π}{p} kt} \qquad ( 42 )$$

In Equation (42), rect(t) represents the rectangular function, which is clearly compactly supported. In order to use g(t) as the sampling kernel, it is set such that s(t)=g(t), bₖ=1, k∈K. For this choice of bₖ, the matrix S in Equation (31) becomes Equation (43):

S=I_{M}. (43)

In Equation (40), r((n−dM)T) can be estimated from the sample pairs {c₁[n], c₂[n]}, n=0, . . . , N−1 as follows in Equation (44):

$$\hat{r} ( ( n - dM ) T ) = \frac{1}{N} {\sum }_{i = 0}^{N - 1} {c}_{1} [ i ] {c}_{2}^{*} [ i - ( n - dM ) ] . \qquad ( 44 )$$

Using Equations (40) and (44), d can be estimated as shown in Equation (45):

\hat{d}=[{tilde over (\hat{r}(0) {tilde over (\hat{r}(T) . . . {tilde over (\hat{r}((M−1)T)]^{T} (45)

In Equation (45), {tilde over (\hat{r}(nT) is the estimate of \tilde{r}(nT). Then, from Equation (38), the estimate of z can be obtained as shown in Equation (46):

$$\hat{z} = \frac{1}{M} {H}^{- 1} {S}^{- 1} W {M}^{- 1} \hat{d} \qquad ( 46 )$$

Once {tₗ}ₗ₌₁^{L} are estimated via the annihilating filter method based on \hat{z}, the LS estimate of {aₗ}ₗ₌₁^{L} can be obtained from Equation (33) as shown in Equation (47):

â=(p/σᵤ²)V^{†}(\hat{t})\hat{z} (47)

In Equation (47), â=[â₁ . . . â_{L}]^{T} and \hat{t}=[\hat{t}₁ . . . \hat{t}_{L}]^{T} are the vectors of amplitude and time-delay estimates respectively, and (·)^{†} is the Moore-Penrose pseudo inverse.

At this point, the estimates â and \hat{t} may be taken to be the final estimates. This estimation approach may be referred to as an IRS approach because the estimates are derived based on the IRS approach, but they do not experience the refining provided by the NLS method, discussed below.

The NLS method has been applied to the parametric estimation of line spectra, as describe by Stoica et al., for example, which consists of finding unknown parameters of complex sinusoids as the minimizers of an NLS criterion. The NLS criterion for the model according to various embodiments may be written as shown in Equation (48):

$${f}_{M} ( t , a ) = {\sum }_{m = 1}^{M} {\vert {\hat{z}}_{m} - \frac{{σ}_{u}^{2}}{p} {\sum }_{l = 1}^{L} {a}_{l} {e}^{- j \frac{ 2 π}{p} ( {k}_{0} + m - 1 ) {t}_{l}} \vert}^{2} \qquad ( 48 )$$

In Equation (46), a=[a₁ . . . a_{L}]^{T}, t=[t₁ . . . t_{L}]^{T}, and \hat{z}ₘ is the m-th entry of the M-dimensional vector \hat{z} computed in Equation (46).

To achieve the NLS refinement, the NLS criterion from Equation (48) is minimized iteratively with respect to a and t based on \hat{z} starting from the initial estimates â and \hat{t}. The use of commercially available software packages for nonlinear least-square minimization, such as one included in Matlab, for example, is a convenient way to execute this minimization. Minimizing the NLS criterion gives asymptotically consistent estimates with the use of the sampling kernel s(t) that satisfies Equation (23) and [Tₛ]<∞. In addition, the iterative minimization procedure for implementing Equation (48) must be correctly initialized sufficiently near the global minimum because the NLS criterion has a complicated multimodal shape with a sharp global minimum. For this purpose, the IRS approach estimates of a and t are used.

In summary, given p and M, the method according to various embodiments method is able to reduce the sampling rate compared to the (near) Nyquist rate by a factor indicated by Equation (49), and still gives consistent estimates of {aₗ, tₗ}ₗ₌₁^{L}:

$${K}_{reduction} = \frac{T}{{T}_{NQ}} = \frac{p}{{MT}_{NQ}} \qquad ( 49 )$$

Special attention must be paid when using a lowpass filter sampling kernel s(t) with real coefficients. In this case, S(ω)=S*(−ω). Thus, if k∈K then −k∈K, which means that only an odd M is permitted with k₀=−(M−1)/2. Thus, the minimal sampling rate that still guarantees asymptotically perfect time-delay estimates is larger than the innovation rate, i.e., 1/T=(2L+1)/p>ρ.

The general NLS method is a particularly efficient estimator when the noise is Gaussian distributed. When applied to the time-difference estimation problem as in Equation (48), it may be less efficient, but it still provides lower estimation variance than other approaches, such the IRS approach used alone.

As discussed above, the time-difference estimation problem can be solved as long as M≧2L. Therefore, given p, M is a design parameter that determines the sampling time interval as T=p/M. Choosing the smallest M, i.e., M=2L, leads to the innovation-rate sampling because 1/T=2L/p=ρ. Increasing M is generally advantageous in terms of estimation performance (at the expense of increased sampling rate) because an increased number of Fourier coefficients are incorporated in the parameter estimation. However, only the Fourier coefficient zₘ should be used where corresponding |H(2π(k₀+m−1)/p)|² has sufficient magnitude to prevent H in Equation (32) from becoming ill-conditioned. Also, k₀ should be chosen in conjunction with M for this purpose. The values k₀ and M eventually specify the sampling kernel s(t) through Equation (23).

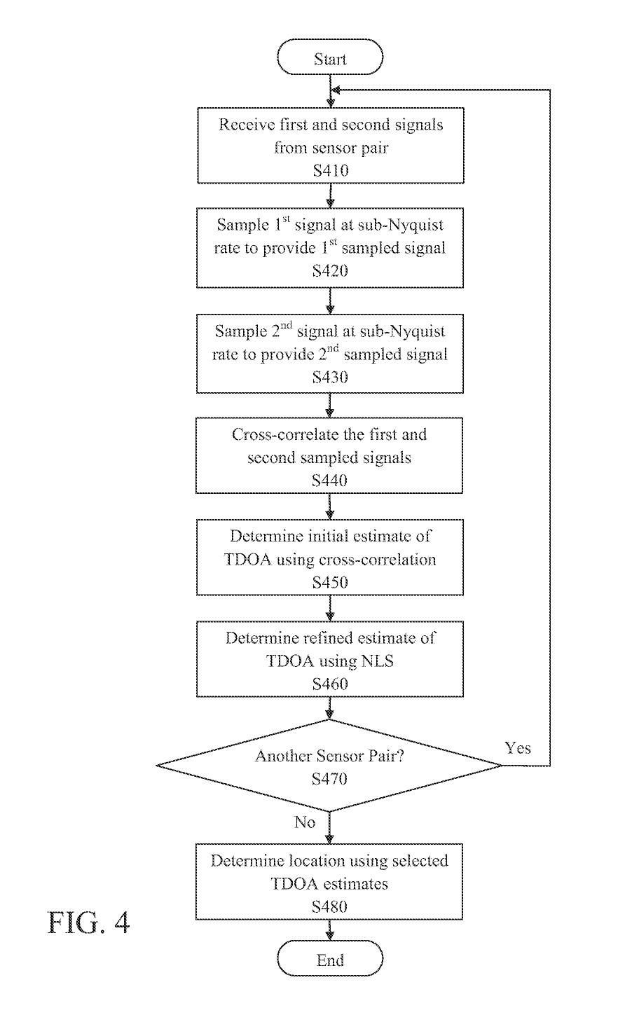

FIG. 4 is a flow chart of a method for estimating TDOA between multipath signals, according to a representative embodiment.

Referring to FIG. 4, first and second signals are received from a sensor pair in block S410. For example, first and second signals 101, 103 are received from a sensor pair including first and second sensors 102, 104. As discussed above, the first and second sensors 102, 104 are in different geographic locations from one another, and receive a transmitted signal (at different times) from a transmitter in an unknown location (e.g., transmitter 150). Generally, the estimated difference in time between when the first and second sensors 102, 104 receive the signal (i.e., the TDOA) is used to determine the location of the transmitter, along with TDOAs estimated using other sensor pairs. The first signal 101 is sampled at a sub-Nyquist rate in block S420 to provide a first sampled signal (e.g., first sampled signal 115). The second signal 103 is sampled at the sub-Nyquist rate in block S430 to provide a second sampled signal (e.g., second sampled signal 116). Because each of the first and second signals 101, 103 is a multiple path signal, the first and second sampled signals 115, 116 form a sample pair in which each of the first and second sampled signals 115, 116 may correspond to a different path signal in the first and second signals 101, 103, respectively.

The first and second sampled signals 115, 116 of each sample pair are cross-correlated in block S440, and an initial estimate of a corresponding TDOA between the first and second signals 101, 103 is determined in block S450 by further processing the cross-correlation determined in block S440. In various embodiments, the initial estimate of the TDOA may be determined through calculations, e.g., as discussed above with regard to Equation (38), and/or use of look-up tables, or the like. In block S460, an NLS method is performed on each initial TDOA estimate to determine a corresponding refined TDOA estimate. Thus, at block S460, one or more refined TDOA estimates are available with respect to the first and second signals 101, 103 (from the corresponding sensor pair 102, 104).

In block S470, it is determined whether there are additional sensor pairs receiving the signal transmitted by the transmitter 150. For example, assuming there is a third sensor (not shown) in addition to the first and second sensors 102, 104, there would be two more possible sensor pairs: the first sensor 102 paired with the third sensor, and the second sensor 104 paired with the third sensor. When there is another sensor pair (block S470: Yes), the process returns and blocks S410 through S470 are repeated for each of the additional sensor pairs to provide corresponding refined TDOA estimates. When there is no additional sensor pair (block S470: No), the process proceeds to block S480, in which the location of the transmitter 150 is determined based on selected one or more refined TDOA estimates corresponding to each of the sensor pairs. For example, as discussed above, it may be assumed that the refined TDOA estimate from each sensor pair having the largest gain represents the LOS TDOA for that sensor pair (i.e., the refined TDOA estimate determined using LOS path signals from both sensors). Thus, the LOS TDOA for each sensor pair may be selected for determining the location of the transmitter 150. However, other criteria may be used for selecting one or more refined TDOA estimates corresponding to each of the sensor pairs, without departing from the scope of the present teachings.

Generally, according to various embodiments, the combined IRS approach and NLS method is applied to estimate time differences between two multipath channels driven by random input signal having known power spectrum, for example. As a result, favorable NLS TDOA estimates are provided from samples taken at sub-Nyquist sampling rates. Given a fixed observation time, this means that the same level of performance is achievable from fewer samples than conventional methods using Nyquist (or greater than Nyquist) sampling rates, for example.

In accordance with illustrative embodiments, a method and apparatus for determining TDOA of signals are described, which may be used for determining the location of a transmitter, for example. One of ordinary skill in the art appreciates that many variations that are in accordance with the present teachings are possible and remain within the scope of the appended claims. These and other variations would become clear to one of ordinary skill in the art after inspection of the specification, drawings and claims herein. The invention therefore is not to be restricted except within the spirit and scope of the appended claims.

What is claimed is:

1. A method for estimating time difference of arrival (TDOA) between first and second multipath signals, where each of the first and second signals represents a multipath channel, the comprising:
sampling the first signal at a sub-Nyquist rate to provide a first sampled signal;
sampling the second signal at the sub-Nyquist rate to provide a second sampled signal; cross-correlating the first and second sampled signals; and
determining an estimate of the TDOA between the first and second signals based on the cross-correlated first and second sampled signals.

2. The method of claim 1, further comprising:
refining the estimate of the TDOA based on a nonlinear least square (NLS) estimate.

3. The method of claim 1, wherein sampling the first and second signals and cross-correlating the first and second sampled signals comprise innovation rate sampling (IRS).

4. The method of claim 1, wherein sampling the first signal comprises lowpass filtering the first signal to provide a first band limited signal and digitizing the first band limited signal, and wherein sampling the second signal comprises lowpass filtering the second signal to provide a second band limited signal and digitizing the second band limited signal.

5. The method of claim 1 wherein each of the first and second signals are sampled at a rate less than a Nyquist rate and greater than or equal to an innovation rate.

6. The method of claim 1, further comprising:
downconverting each of the first and second signals.

7. The method of claim 1, wherein determining the estimate of the TDOA comprises performing an annihilating filter method.

8. The method of claim 7, wherein the annihilating filter method comprises a parametric estimation method for line spectra with super-resolution capability.

9. A method, instantiated in a computer readable medium storing programming instructions and executable by a processor, to determine time difference of arrival (TDOA) between a first signal and a second signal, the method comprising:
sampling a first signal at a sub-Nyquist rate to provide a first sampled signal;
sampling a second signal at the sub-Nyquist rate to provide a second sampled signal, the first and second signals representing corresponding multipath channels of an input signal from a transmitter;
cross-correlating the first and second sampled signals; and
determining an estimate of the TDOA between the first signal and the second signal based on the cross-correlated first and second sampled signals.

10. The method of claim 9, further comprising:
refining the estimate of the TDOA based on a nonlinear least square (NLS) estimate.

11. The method of claim 9, wherein sampling the first and second signals and cross-correlating the first and second sampled signals comprise innovation rate sampling (IRS).

12. The method of claim 9, wherein sampling the first signal and sampling the second signal each occurs at a rate less than a Nyquist rate and greater than or equal to an innovation rate.

13. An apparatus, comprising:
a first device configured to sample a first signal from a first sensor at a sub-Nyquist rate to provide a first sampled signal;
a second device configured to sample a second signal from a second sensor at the sub-Nyquist rate to provide a second sampled signal; and
a module configured to cross-correlate the first and second sampled signals and to provide estimates of time difference of arrival (TDOA) between the first and second signals corresponding to a sampling period based on the cross-correlated first and second sampled signals,
wherein the first and second signals correspond to an input signal from a transmitter.

14. The apparatus of claim 13, further comprising:
a first input node configured to receive the first signal from the first sensor; and
a second input node configured to receive the second signal from the second sensor, the second sensor being at a different geographic location than the first sensor.

15. The apparatus of claim 13, further comprising:
another module configured to receive the estimates of the TDOA and to further refine the estimates of the TDOA based on nonlinear least square (NLS) estimates.

16. The apparatus of claim 13, wherein each of the first signal and the second signal is sampled and cross-correlation is performed by innovation rate sampling (IRS).

17. The apparatus as claimed in claim 13, wherein each of the first signal and the second signal is sampled at a rate less than a Nyquist rate and greater than or equal to an innovation rate.

18. The apparatus of claim 13, wherein the first device comprises a first lowpass filter and a first analog-to-digital converter (ADC), the first lowpass filter being configured to receive the first signal and to provide a first band limited signal to the first ADC; and
wherein the second device comprises a second lowpass filter and a second ADC, the second lowpass filter being configured to receive the second signal and to provide a second band limited signal to the second ADC.

19. The apparatus of claim 15, further comprising:
a processor configured to determine a location of the transmitter using the refined TDOA estimates.

20. The apparatus of claim 15, wherein each of the module and the other module is implemented by one or more computer processors.
